(19) United States
(12) Patent Application Publication
(10) Pub. No.: US 2005/0219389 A1
(43) Pub. Date: Oct. 6, 2005

(54) Efficient fluctuating signal subtraction in a signal processing circuit and an image capturing apparatus

(75) Inventor: Takafumi Nakamori, Mizuho-City (JP)

Correspondence Address: MCDERMOTT WILL & EMERY LLP, 600 13TH STREET, N.W., WASHINGTON, DC, 20005-3096, US

(73) Assignee: Sanyo Electric Co., Ltd.

(21) Appl. No.: 11/092,813

(22) Filed: Mar. 30, 2005

(30) Foreign Application Priority Data
Mar. 31, 2004 (JP) 2004-102448

(51) Int. Cl. H04N 5/228; H04N 5/217

(52) U.S. Cl. 348/241; 348/222.1

(57) ABSTRACT

A digital circuit unit adaptively predicts noise and outputs the predicted noise to an analog circuit unit as a subtracter signal. The subtracter signal is input via a D/A converter to a subtractor signal wherein the noise is removed from the analog input signal. An output from the subtractor circuit is amplified by a variable gain amplifier circuit so that the amplified signal is converted into a digital signal by an A/D converter.

### BACKGROUND OF THE INVENTION

1. Field of the Invention

The present invention relates to a signal processing circuit and an image capturing apparatus in which an analog signal output from an image capturing device or the like is amplified and subsequently converted into a digital signal.

2. Description of the Related Art

In performing analog-to-digital (A/D) conversion on an analog signal with a dynamic range significantly fluctuating depending on use conditions, a general approach practiced in the related art is to provide a variable gain amplifier circuit to precede an A/D converter circuit and to control the gain of the variable gain amplifier circuit such that the amplitude of the analog signal does not go beyond the input voltage range of the A/D converter circuit as disclosed in Japanese Laid-Open Patent Application H5-41797. Such an approach is designed to improve the pseudo resolution in converting into a digital signal.

It will now be assumed that the resolution of the A/D converter circuit is 10 bits and the input voltage range is 1

Assuming that the amplitude of an externally supplied analog input signal is 0.5 V, the gain of the variable gain amplifier circuit is controlled to 2 so that the signal amplitude is amplified to 1 V before being input to the A/D converter circuit. The A/D converter circuit converts the analog signal with its amplitude amplified to 1 V into a digital signal with a resolution of 10 bits. This is equivalent to conversion from the analog signal with the amplitude of 0.5 V into a digital signal with a pseudo-resolution of 11 bits.

Assuming that the amplitude of an externally supplied analog input signal is 0.25 V, the gain of the variable gain amplifier circuit is controlled to 4 so that the signal amplitude is amplified to 1 V before being input to the A/D converter circuit for conversion into a digital signal with a resolution of 10 bits. This is equivalent to conversion from the analog signal with the amplitude of 0.25 V into a digital signal with a pseudo-resolution of 12 bits. Thus, it is ensured that the smaller the amplitude of analog input signal, the larger the pseudo-resolution, by increasing the gain of the variable gain amplifier circuit.

The externally supplied analog input signal includes undesired signals such as an offset signal and noise in addition to information (for example, a pixel charge signal) required by a digital circuit unit subsequent to analog-to-digital conversion. In the general practice, the analog input, signal is amplified by the variable gain amplifier circuit with these undesired signals being contained therein. The amplified analog signal is converted into a digital signal by the A/D converter circuit. The undesired signals are removed by a digital circuit unit. Such a structure, however, is an impediment in itself to improvement in pseudo-resolution.

Y. Fujimoto et al. proposed this with a structure illustrated in FIG. 1 in the related art, in which undesired signals are removed by a subtractor circuit that precedes a variable gain amplifier circuit. According to this approach, a predetermined black level offset signal is subtracted from an analog input signal.

What is removed in a stage preceding the variable gain amplifier circuit in the structure disclosed in the related art by Y. Fujimoto et al. is a predetermined, fixed value. A fluctuating value cannot be removed. More specifically, amplification in the variable gain amplifier circuit is done with undesired fluctuating signals (for example, noises like fixed pattern noise or smear, or a signal corresponding to predicted image data produced when calculating a difference between input image data and predicted image data) being contained in the amplified signal. The amplified signal is converted into a digital signal by an A/D converter circuit. Accordingly, improvement in pseudo-resolution is prevented.

Related Art List

JPA laid open H5-41797

Y. Fujimoto et al, “A Switched-Capacitor Variable Gain Amplifier for CCD Image Sensor Interface System”, ESSCIRC 2002, pp. 363-366, 2002

### SUMMARY OF THE INVENTION

The present invention has been done in view of the aforementioned circumstances and its object is to provide a signal processing technology that will prove effective in the presence of undesired fluctuating signals.

The present invention according to one aspect provides a signal processing circuit. The circuit according to this aspect comprises: a subtractor circuit which subtracts from an analog input signal; an amplifier circuit which amplifies an output from the subtractor circuit; an A/D converter which converts an output from the amplifier circuit into a digital signal; and a digital circuit unit which processes the digital signal generated by the A/D converter, wherein the digital circuit unit generates an undesired signal that varies with an attribute of the input signal and that is input to the subtractor circuit after being converted into an analog signal. According to this aspect, the undesired signal is subtracted in a stage preceding the amplifier circuit.

The attribute of the input signal may be identification of an area in an image capturing apparatus originating the input signal currently input. Alternatively, the attribute may be identification of a pixel in the image capturing apparatus originating the input signal currently input. Further, the attribute may be the magnitude of input signal, a duration in which the input occurs or any information related to the input signal.

The digital circuit unit may further generate a gain signal indicating the gain of the amplifier circuit. In this case, the value of the gain signal may be determined such that the amplitude of output of the amplifier circuit does not exceed the input level range of the A/D converter. With this, pseudo-resolution on the signal with the undesired signal being removed therefrom is increased.

The present invention according to another aspect provides a signal processing circuit. The circuit according to this aspect comprises: a subtractor circuit which subtracts a signal corresponding to noise from an analog input signal; an amplifier circuit which amplifies an output of the subtractor circuit; and a noise prediction circuit which generates the signal corresponding to noise, wherein the noise prediction circuit defines the signal corresponding to noise in accordance with a system originating the input signal. According to this aspect, a noise signal can be predicted in accordance with a processing system.

Arbitrary combinations of the aforementioned constituting elements, and implementations of the invention in the form of methods, apparatuses and systems may also be practiced as additional modes of the present invention.

### BRIEF DESCRIPTION OF THE DRAWINGS

FIG. 1A illustrates the structure of a frame transfer CCD.

FIG. 1B illustrates how signal charges are built up in a frame transfer CCD.

FIG. 1C illustrates pixel-dependence of signal charge stored in a frame transfer CCD.

FIG. 2 is a block diagram illustrating a signal processing circuit according to a first embodiment.

FIG. 3 is a block diagram illustrating a signal processing circuit according to a second embodiment.

FIG. 4 is a block diagram illustrating a signal processing circuit according to a third embodiment.

### DETAILED DESCRIPTION OF THE INVENTION

### First Embodiment

A description of preferred embodiments will be given. The first embodiment is concerned with a signal processing circuit which subtracts smear predicted in a digital circuit unit from an analog signal input from a frame transfer CCD, an image capturing apparatus, and which amplifies the signal after subtraction before converting it into a digital signal.

Smear is a phenomenon which appears as a bright vertical stripe resulting from leakage of charge generated in an image capturing unit into a charge transfer unit when a bright light is incident on the apparatus. The smear characteristic to the structure of a frame transfer CCD is also generated.

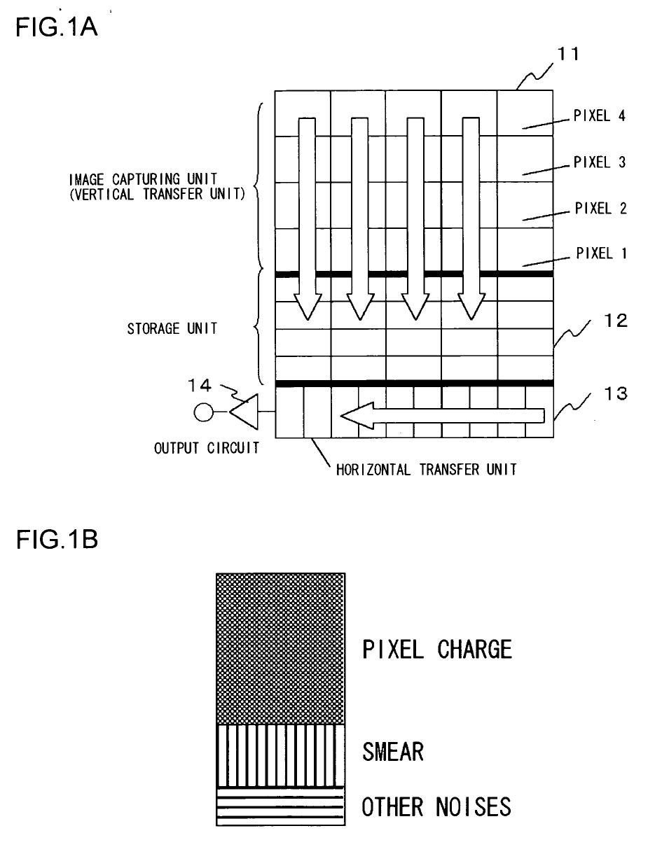

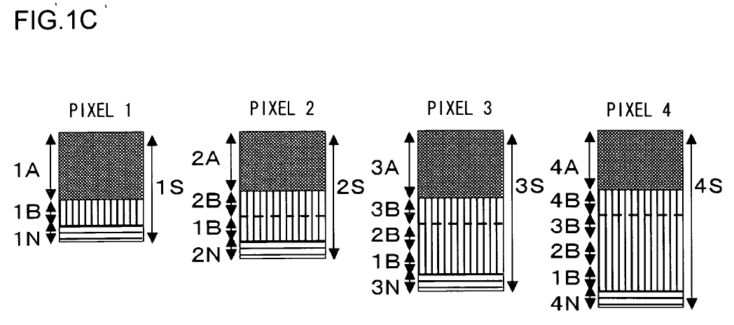

FIG. 1A illustrates the structure of a frame transfer CCD. The frame transfer CCD comprises an image capturing unit 11 for converting incident light into charge, a light shielded storage unit 12, a horizontal transfer unit 13 for transferring the charge transferred from the storage unit 12 to an output circuit 14, and an output circuit 14 for converting the charge into a voltage for output to an external device. The image capturing unit 11 also serves as a vertical transfer unit. The charge derived from conversion in the image capturing unit 11 during an imaging period is transferred to the storage unit 12 immediately after the imaging period so as to prevent additional light from being incident on the CCD.

FIG. 1B illustrates how signal charges at a pixel are built up in the storage unit 12. The signal charges at a pixel built up in the storage unit 12 are grouped into pixel charges, smear and other noises. The pixel charges are generated from incident light during the imaging period and represent genuine image information.

Smear results from buildup of charges generated from light incident on the image capturing unit 11 while charges are transferred from the image capturing unit 11 to the storage unit 12 immediately after the imaging period. More specifically, smear is generated due to a structure in which the image capturing unit 11 of a frame transfer CCD doubles as a vertical transfer unit and appears as undesired signal charges generated outside the imaging period.

The phrase “the other noises” refers to various noises generated inside the CCD. For example, the other noises include fixed pattern noise caused by an associated manufacturing process or an associated quality of crystal forming a substrate. The other noises also include random noise due to performance fluctuation in the constituting elements.

FIG. 1C illustrates how pixel 1, pixel 2, pixel 3 and pixel 4 illustrated in FIG. 1A originate the signal charges of FIG. 1B, showing a measure of proportion occupied by each origin of the charges. FIG. 1C shows that smear is more abundant as the distance for transfer from the image capturing unit 11 to the storage unit 12 increases. This is due to the fact that the longer the distance of transfer, the longer the time exposed to light.

As already explained, the pixel charges are generated in response to light incident during the imaging period. In contrast, smear is generated in response to light incident outside the imaging period. Therefore, the amount of smear is predicable from output signal charges, by referring to imaging time and transfer time.

Referring to FIG. 1C, a description will now be given of a method of predicting smear at each pixel. An assumption here is that the light with the same intensity is incident on the image capturing unit 11 in the imaging period and in the transfer period. For prediction of smear, prediction is started at pixel 1 closest to the storage unit 12. A ratio (1A:1B) between the amount 1A of pixel charges at pixel 1 and the amount 1B of smear at pixel 1 is represented by a ratio (TA:TB) between imaging time 1A and transfer time TB required for vertical transfer of pixel charges at one pixel. Accordingly, given that the amount of signal charges at pixel 1 is denoted by 1S and the amount of noises other than smear is denoted by 1N, the amount 1B of smear at pixel 1 is given as follows.
1B=TB·(1S−1N)/(TA+TB) (1)

Subsequently, the smear at pixel 2 is predicted. The charges built up in pixel 2 are transferred to the storage unit 12 via pixel 1 in the image capturing unit 11. Accordingly, the signal charges 2S at pixel 2 include the smear at pixel 1 in a stage in which the charges at pixel 2 are transferred to the storage unit 12. In a similar way to pixel 1, a ratio between the amount 2A of pixel charges at pixel 2 and the amount 2B of smear at pixel 2 is represented by a ratio (TA:TB) between the imaging time TA and the transfer time TB required for vertical transfer of pixel charges at one pixel. Accordingly, given that the amount of noises other than smear is denoted by 2N, the amount 2B of smear at pixel 2 is given as follows.
2B=TB·(2S−2N−1B)/(TA+TB) (2)

The smear at pixel 3 can be determined in a similar way to pixel 2. More specifically, the signal charges 3S at pixel 3 include the smear 1B at pixel 1 and the smear 2B at pixel 2 since the charges at pixel 3 are transferred to the storage unit 12 via pixel 1 and pixel 2 in the image capturing unit 11. A ratio between the amount 3A of pixel charges at pixel 3 and the amount 3B of smear at pixel 3 is represented by a ratio (TA:TB) between the imaging time TA and the transfer time TB required for vertical transfer of pixel charges at one pixel. Therefore, given that the amount of noises other than smear at pixel 3 is denoted by 3N, the amount 3B of smear at pixel 3 is given as follows.
3B=TB·(3S−3N−1B−2B)/(TA+TB) (3)

Thus, the smear at each pixel will be sequentially predicted in a vertical direction. In the inventive method of prediction, subtracted from the signal charges at a target pixel for prediction are the noises at the target pixel other than smear, and the smear at pixels in the image capturing unit 11 through which the pixel charges pass in the process of transfer to the storage unit 12. The result from subtraction is proportionally distributed by a ratio (TA:TB) between the imaging time TA and the transfer time TB required for vertical transfer of pixel charges at one pixel.

In the above description, the noises other than smear are subtracted. Alternatively, an arbitrary preset value may be subtracted as representing the other noises. The arbitrary preset value may be 0. Of the other noises, fixed pattern noise is measurable. Therefore, the fixed pattern noise determined by measurement may be subtracted as representing the other noises. Alternatively, a sum of the fixed pattern noise determined by measurement and an arbitrary preset value representing random noise may be subtracted as representing the other noises. The above-mentioned approach for prediction may not provide an accurate measure of the smear. It will be noted that determination of a predicted value of the smear is important and that it is not necessary to obtain an accurate value.

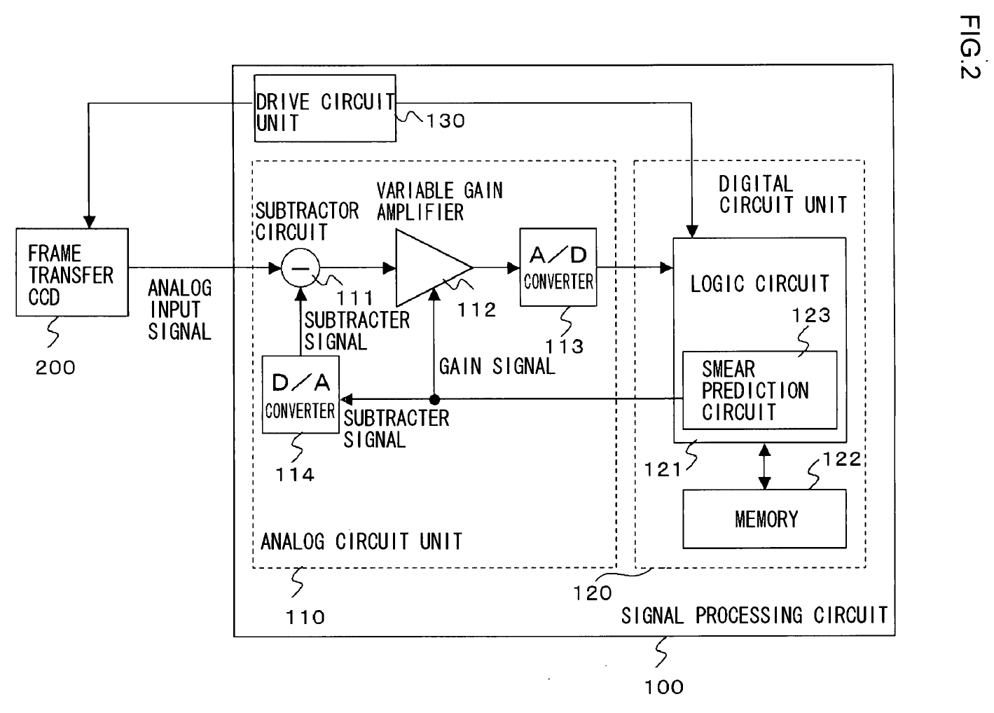

A description will now be given of a signal processing circuit 100 according to the first embodiment. FIG. 2 is a block diagram illustrating the structure of the signal processing circuit 100 according to the first embodiment. The signal processing circuit 100 includes an analog circuit unit 110 for amplifying an analog input signal input from a frame transfer CCD 200 and converting the signal into a digital signal, a digital circuit unit 120 for subjecting the digital signal produced by conversion in the analog circuit unit 110 to digital processing, and a drive circuit unit 130 for driving the frame transfer CCD 200. The signal processing circuit 100 and the frame transfer CCD 200 may constitute a digital camera.

The analog circuit unit 110 includes a subtractor circuit 111 for subtracting from the analog input signal, a variable gain amplifier circuit 112 with a variable gain for amplifying the analog signal subjected to subtraction in the subtractor circuit 111, an A/D converter 113 for converting the analog signal amplified by the variable gain amplifier circuit 112 into a digital signal. The analog circuit unit 110 also includes a D/A converter 114 for converting a subtracter signal input from the digital circuit unit 120 into an analog signal. An output from the D/A converter 114 is input to the subtractor circuit 111 as a subtracter. A gain signal from the digital circuit unit 120 is input to the variable gain amplifier circuit 112 so that the variable gain amplifier circuit 112 amplifies by a gain designated by the gain signal.

The digital circuit 120 includes a logic circuit 121 for performing a predetermined process on the digital signal input from the analog circuit unit 110 or other digital signals, and a memory 122 for temporarily storing data. The logic circuit 121 includes a smear prediction circuit 123 for predicting the amount of smear. The value obtained by prediction in the smear prediction circuit 123 is output to the analog circuit unit 110 as the subtracter signal. The value of the gain signal is determined by referring to the predicted value of the smear such that the amplitude of output from the amplifier circuit does not exceed the input level range of the A/D converter.

The drive circuit unit 130 generates a drive signal to drive the frame transfer CCD 200. In addition, the drive circuit unit 130 generates an address indicating a pixel position associated with data output from the frame transfer CCD 200. The address is input to the digital circuit 120. Parameters including the imaging time TA and the transfer time TB for driving the frame transfer CCD 200 are also input from the drive circuit unit 130 to the digital circuit unit 120.

A description will now be given of the operation of the signal processing circuit 100. Image capturing is done in the frame transfer CCD 200 in accordance with the drive signal from the drive circuit unit 130. Subsequently, the signal charges are converted into signal voltages in the frame transfer CCD 200. The signal voltages are output pixel by pixel as the analog input signal. The analog input signal is initially amplified by the variable gain amplifier 112 without undergoing the subtracting operation by the subtractor circuit 111. The A/D converter 113 converts the analog input signal into a digital signal before for input to the digital circuit unit 120.

The smear prediction circuit 123 provided in the logic circuit 121 predicts the smear at each pixel, in accordance with the smear prediction method already described, by referring to the digital signal input from the analog circuit unit 110, the imaging time TA and the transfer time TB input from the drive circuit unit 130. The predicted value is temporarily stored in the memory 122.

The above-mentioned operation is repeated for the entire pixels in the frame transfer CCD until the signal voltages are read out from them. Ultimately, the predicted values of smear for the entire pixels are stored in the memory 122.

Subsequently, image capturing is done again by the frame transfer CCD 200 in accordance with the drive signal from the drive circuit unit 130 so that the signal voltages for respective pixels are output as the analog input signal. In this state, the logic circuit 121 reads out, from the memory 122, the smear at the same pixel as the pixel originating the analog input signal output from the frame transfer CCD 200, in accordance with the address output from the drive circuit unit 130. The logic circuit 121 outputs the smear thus read out as the subtracter signal. More specifically, the smear determined pixel by pixel in accordance with the amount of signal charges, the imaging time and the transfer time is selected depending on which pixel in the frame transfer CCD 200 outputs the analog input signal currently input. The smear thus selected is output as the subtracter signal. That is, the subtracter signal varies in adaptation to attributes of the analog input signal including the amount of signal charges, the imaging time, the transfer time and the identify of pixel in the frame transfer CCD 200 originating the analog input signal currently input.

The subtracter signal is converted into an analog signal by the D/A converter 114 and the resultant analog signal is input to the subtractor circuit 111 as the subtracter. The subtractor circuit 111 subtracts the subtracter from the analog input signal, the minuend. This will result in the smear being removed from the analog input signal. The analog signal after the subtraction is composed of a pixel charge signal essentially representing genuine image information.

The analog signal after the subtraction is input to the variable gain amplifier circuit 112. There, the analog signal is amplified by a gain determined such that an output from the variable gain amplifier circuit 112 does not exceed the input range of the A/D converter 113. The amplified analog signal is converted into a digital signal by the A/D converter 113 for output to the digital circuit unit 120 where the digital signal is subject to predetermined image processing computation.

Thus, by subtracting an undesired fluctuating signal at a stage preceding the variable gain amplifier circuit 112, signal processing with improved precision is achieved.

According to the structure described above, the smear is predicted in adaptation to the amount of signal charges, the imaging time, the transfer time and the identify of pixel in the image capturing apparatus originating the analog input signal currently input. The smear can be subtracted from the analog input signal before the being amplified by the variable gain amplifier circuit 112. Since this results in the signal amplified by the variable gain amplifier circuit 112 being essentially composed a pixel charge signal representing genuine image information, signal processing with improved precision is achieved.

Application of the inventive signal processing is not limited to the frame transfer CCD as described in this embodiment. The smear generated in an image capturing apparatus of any of other types may be predicted and subtracted from an analog input signal. In this case, a method for predicting the smear may be determined in accordance with the structure of the image capturing apparatus.

### Second Embodiment

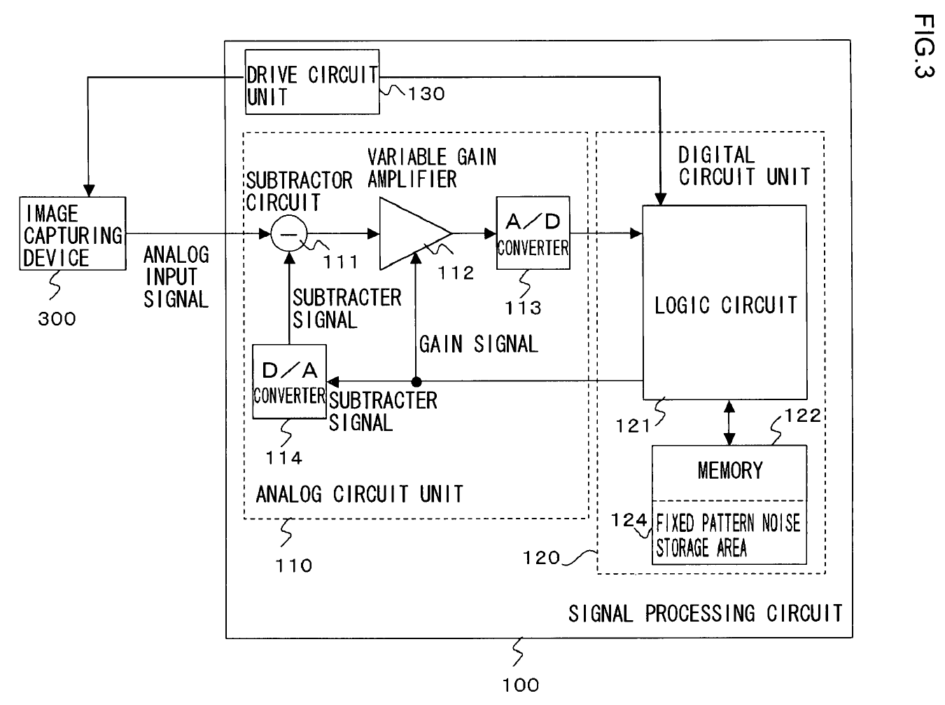

FIG. 3 is a block diagram illustrating the structure of the signal processing circuit 100 according to the second embodiment. The signal processing circuit 100 amplifies the analog signal input from an image capturing device 300 after subtracting therefrom fixed pattern noise predicted by a digital circuit unit. The signal processing circuit 100 converts the amplified signal into a digital signal. Since the structure is similar to that of the signal processing circuit 100 illustrated in FIG. 2, only those features unique to the second embodiment will be described. In a similar way to the first embodiment, the signal processing circuit 100 and the image capturing device 300 may constitute a digital camera.

When the image capturing device 300 is driven by a drive signal generated by the drive circuit unit 130 in a light shielded condition, the analog input signal from the image capturing device 300 will be a composite of fixed pattern noise and random noise. The analog input signal in this condition is initially input to the analog circuit unit 110. Subtraction by the subtractor circuit 111 is not performed. The analog input signal is converted into a digital signal by the A/D converter circuit 113 before being input to the digital circuit unit 120.

The logic circuit 121 predicts the fixed pattern noise for the entire pixels in the image capturing device 300 by referring to the input digital signal. The predicted fixed pattern noise is stored in a fixed pattern noise storage area 124 in the memory 122. A method of predicting the fixed pattern noise may be subtraction of random noise, assumed to be constant, from the digital signal. Alternatively, the input digital signal may be directly used as a predicted value of the fixed pattern noise. Alternatively, the fixed pattern noise may be predicted such that the imaging by the image capturing device 300 is performed a plurality of times in a light shielded condition so as to obtain a plurality of sets of image data each composed of fixed pattern noise and random noise, and the random noise is then removed by passing the image data through a low-pass filter (LPF).

When an image is subsequently captured by the image capturing device 300, the logic circuit 121 reads out, from the fixed pattern noise storage area 124, the fixed pattern noise at the same pixel as the pixel originating the analog input signal output from the image capturing device 300, in accordance with the address output from the drive circuit unit 130. The logic circuit 121 outputs the fixed pattern noise thus read out as the subtracter signal. That is, the subtracter signal varies in adaptation to an attribute of the analog input signal, i.e., the identify of pixel in the image capturing device 300 originating the analog input signal currently input.

The subtracter signal is input as the subtracter to the subtractor circuit 111 via the D/A converter 114. The subtractor circuit 111 subtracts an undesired signal (in this embodiment, the fixed pattern noise) from the analog input signal. Thereafter, the analog signal after the subtraction is amplified by the variable gain amplifier circuit 112 by a gain determined such that the output from the variable gain amplifier circuit 112 does not exceed the input range of the A/D converter 113. The amplified analog signal is converted into a digital signal by the A/D converter 113 for output to the digital circuit unit 120.

According to the structure described above, the fixed pattern noise unique to the image capturing device 300 is adaptively predict and can be subtracted from the analog input signal before being amplified by the variable gain amplifier circuit 112. Since this results in the signal amplified by the variable gain amplifier circuit 112 being essentially composed a pixel charge signal representing genuine image information, signal processing with improved precision is achieved.

### Third Embodiment

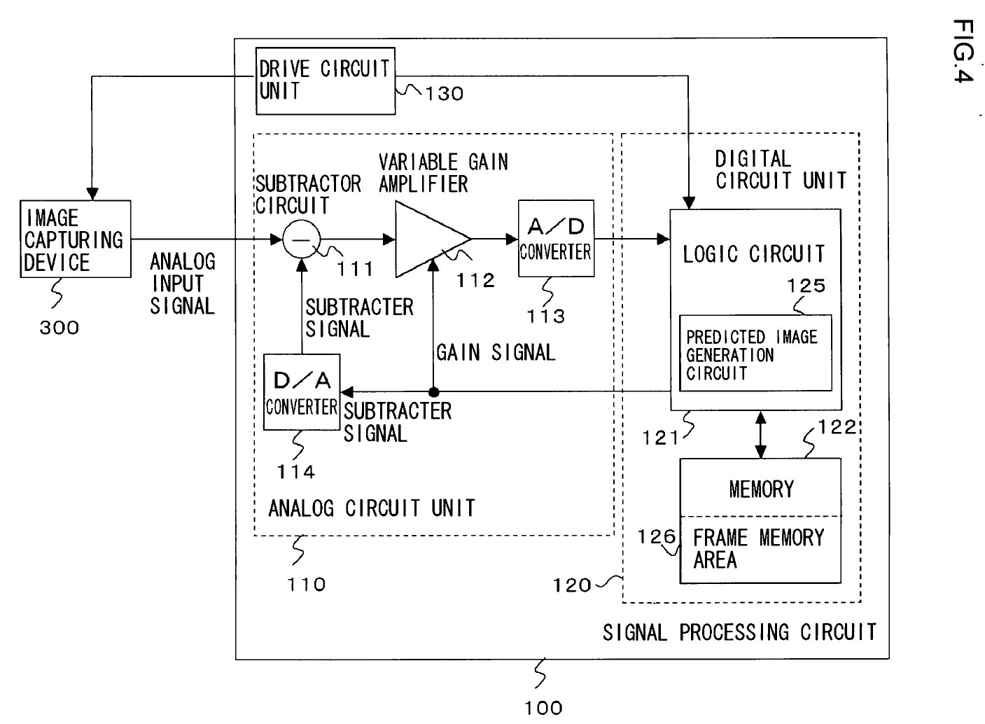

FIG. 4 is a block diagram illustrating the structure of the signal processing circuit 100 according to the third embodiment. The signal processing circuit 100 calculates a difference between input image data and predicted image data and subjects resultant difference image data to computation. In the related art, calculation of the difference image data is done in a digital circuit unit. According to this embodiment, a predicted image signal generated in the digital circuit unit is subtracted from the analog signal input from the image capturing device 300 so as to obtain a difference image signal. The difference image signal is amplified and converted into a digital signal. Since the structure is similar to that of the signal processing circuit 100 illustrated in FIG. 2, only those features unique to the third embodiment will be described. In a similar way to the first embodiment, the signal processing circuit 100 and the image capturing device 300 may constitute a digital camera.

The memory 122 of the digital circuit unit 120 is provided with a frame memory area 126 where a plurality of sets of image data are stored as reference image data. The logic circuit 121 is provided with a predicted image generating circuit 125.

When a prediction process using the reference image is not performed on an image signal output from the image capturing device 300, subtraction by the subtractor circuit 111 in the analog circuit unit 110 is not performed. The analog input signal is directly amplified by the variable gain amplifier circuit 112 and then converted into a digital signal by the A/D converter circuit 113 for input to the digital circuit unit 120.

When a prediction process using the reference image is performed on the image signal output from the image capturing device 300, the following operation is performed.

The predicted image generation unit 125 determines the identify of area in the image capturing device 300 originating the analog input signal currently input from the image capturing device 300, in accordance with the address generated by the drive circuit unit 130. The predicted image generation unit 125 reads out, from the reference image data stored in the frame memory area 126, one or a plurality of sets of image data for a determined area, and subjects the image data thus read out to a predetermined process so as to generate the predicted image data. From among the predicted image, the logic circuit 121 selects the image data corresponding to the pixel position associated with the analog input signal currently input, in accordance with the address generated by the drive circuit unit 130. The signal corresponding to the selected image data is output to the analog circuit unit 110 as the subtracter signal. Accordingly, the subtracter signal varies in adaptation to an attribute of the analog input signal, i.e., the identify of area/pixel in the image capturing device 300 originating the analog input signal currently input.

The subtracter signal is input as the subtracter to the subtractor circuit 111 via the D/A converter 114. The subtractor circuit 111 subtracts the signal corresponding to the predicted image data from the analog input signal so as to determine the difference image data. The difference image data is amplified by the variable gain amplifier circuit 112 in accordance with the gain signal designating a gain determined such that the output does not exceed the input range of the A/D converter 113. The A/D converter 113 converts the amplified signal into a digital signal for output to the digital circuit unit 120.

Thus, according to the structure described above, the predicted image data is adaptively generated. The difference image data is obtained by removing the predicted image data from the analog input signal before being amplified by the variable gain amplifier circuit. By amplifying the difference image data by the variable gain amplifier circuit, signal processing with higher precision on the difference image data is achieved.

Described above is an explanation based on the embodiment. The embodiment is only illustrative in nature and it will be obvious to those skilled in the art that variations in constituting elements and processes are possible within the scope of the present invention.

For example, the signal processing circuit 100 of FIG. 2 and the signal processing circuit 100 of FIG. 3 may be combined to constitute a signal processing circuit. In this case, the digital circuit unit 120 predicts both the smear and the fixed pattern noise according to the method described in the respective embodiments. A sum of the predictions may be removed as the subtracter signal from the input signal. When the fixed pattern noise in the input signal is negligibly smaller than the smear, only the smear may be predicted for use as the subtracter signal. When the smear is negligibly smaller than the fixed pattern noise, only the fixed pattern noise may be predicted for use as the subtracter signal. According to this structure, signal processing with even higher precision is achieved for a variety of inputs since a noise signal is predicted in accordance with a system originating the input.

1. A signal processing circuit comprising:
a subtractor circuit which subtracts from an analog input signal;
an amplifier circuit which amplifies an output from the subtractor circuit;
an A/D converter which converts an output from the amplifier circuit into a digital signal; and
a digital circuit unit which processes the digital signal generated by the A/D converter, wherein
the digital circuit unit generates an undesired signal that varies with an attribute of the input signal and that is input to the subtractor circuit after being converted into an analog signal.

2. The signal processing circuit according to claim 1, wherein the undesired signal includes a signal corresponding to noise contained in the input signal.

3. The signal processing circuit according to claim 1, wherein the digital circuit unit further generates a gain signal indicating the gain of the amplifier circuit, the value of the gain signal may be determined such that the amplitude of output of the amplifier circuit does not exceed the input level range of the A/D converter.

4. The signal processing circuit according to claim 3, wherein the undesired signal includes a signal corresponding to noise contained in the input signal.

5. The signal processing circuit according to claim 1, wherein the input signal is a signal corresponding to a pixel in an image output from an image capturing device, the digital circuit unit generates the undesired signal corresponding to each pixel, and the subtractor circuit subtracts, pixel by pixel, the undesired signal from the input signal.

6. The signal processing circuit according to claim 5, further comprising a drive circuit unit which drives the image capturing device and sends identification information identifying a pixel position associated with the input signal to the digital circuit unit, wherein the digital circuit unit generates the undesired signal corresponding to the input signal by referring to the identification information.

7. The signal processing circuit according to claim 2, wherein the input signal is a signal output from a frame transfer charge-coupled device, the noise includes smear, and the digital circuit unit generates a signal corresponding to smear by referring to imaging time and transfer time in the frame transfer charge-coupled device.

8. The signal processing circuit according to claim 4, wherein the input signal is a signal output from a frame transfer charge-coupled device, the noise includes smear, and the digital circuit unit generates a signal corresponding to smear by referring to imaging time and transfer time in the frame transfer charge-coupled device.

9. The signal processing circuit according to claim 5, wherein the undesired signal includes a signal corresponding to fixed pattern noise contained in the input signal, the fixed pattern noise is stored in a memory provided in the digital circuit unit pixel by pixel for use in the subtractor circuit.

10. The signal processing circuit according to claim 1, wherein the digital circuit unit comprises a logic circuit and a memory and stores a plurality of sets of reference image data in the memory, the logic circuit generates predicted image data from the reference image data, and the undesired signal includes a signal corresponding to the predicted image data.

11. The signal processing circuit according to claim 3, wherein the digital circuit unit comprises a logic circuit and a memory and stores a plurality of sets of reference image data in the memory, the logic circuit generates predicted image data from the reference image data, and the undesired signal includes a signal corresponding to the predicted image data.

12. A signal processing circuit comprising:
a subtractor circuit which subtracts a signal corresponding to noise from an analog input signal;
an amplifier circuit which amplifies an output of the subtractor circuit; and
a noise prediction circuit which generates the signal corresponding to noise, wherein
the noise prediction circuit defines the signal corresponding to noise in accordance with a system originating the input signal.

13. An image capturing apparatus comprising: an image capturing device;
a drive circuit unit which drives the image capturing device; and
a signal processing circuit according to claim 1, wherein
the signal processing circuit subjects a signal output from the image capturing device to signal processing.

14. An image capturing apparatus comprising:
an image capturing device;
a drive circuit unit which drives the image capturing device; and
a signal processing circuit according to claim 12, wherein
the signal processing circuit subjects a signal output from the image capturing device to signal processing.
